(19) United States
(12) Patent Application Publication
(10) Pub. No.: US 2012/0150759 A1
(43) Pub. Date: Jun. 14, 2012

(54) NON-GAMING ON-LINE ACHIEVEMENT AWARDS

(75) Inventor: Paul Tarjan, San Jose, CA (US)

(73) Assignee: Yahoo! Inc., Sunnyvale, CA (US)

(21) Appl. No.: 12/964,707

(22) Filed: Dec. 9, 2010

(51) Int. Cl. G06Q 30/00; G06Q 99/00

(52) U.S. Cl. 705/319; 705/1.1

(57) ABSTRACT

Example methods, apparatuses, or articles of manufacture are disclosed that may be implemented using one or more computing devices to facilitate or otherwise support one or more processes or operations associated with non-gaming on-line achievement awards for use in or with information or award management systems.

### BACKGROUND

1. Field

The present disclosure relates generally to information processing in awards management systems and, more particularly, to non-gaming on-line achievement awards for use in or with information or award management systems.

2. Information

The World Wide Web or simply the Web, provided by the Internet, is growing rapidly, at least in part, from the large amount of information being added regularly. A wide variety of information, such as, for example, web pages, text documents, images, audio files, video files, or the like is continually being identified, located, retrieved, accumulated, communicated, or stored. In addition, social communication paradigms supported by the Internet, such as, for example, on-line social networks or virtual communities have become commonplace, as have related communication networks or computing resources that help users or community members to access, share, or communicate information of interest. Today, a number of on-line social networking services may feature various information databases including, for example, collections of service provider-generated content (e.g., web-based news agencies, newspaper services, movie or entertainment portals, travel or shopping sites, etc.), user-generated content (e.g., knowledge databases, image or photo sharing databases, etc.), or the like, with new on-line content seemingly being added daily.

With such an overabundance of information being available or accessible over the Internet, on-line service providers including, for example, search engines, electronic communication or messaging systems (e.g., e-mail, instant messaging, etc.), social networking platforms (e.g., blogs, discussion forums, bulletin boards, profile homepages, etc.), or the like may wish or desire to increase user engagement or strengthen user loyalty. For example, effectively or efficiently locating or retrieving information on the Web may facilitate or support information-seeking behavior of users (e.g., via more satisfying user experience, etc.), thus, leading to increased usability of a search engine. Likewise, providing targeted or behavioral incentives may compel or encourage certain users to explore a range of on-line product offerings (e.g., new or under-utilized features, popular functionalities or promotions, etc.) that may be unknown or otherwise may not appeal to such users. However, how to compel or otherwise encourage users, for example, into behaviors or interactions with on-line service providers in a desired manner or steer users into desired on-line functionalities continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating an implementation of an example computing environment.

FIGS. 2A through 2E are illustrative representations of screenshot views of an implementation of a user display.

FIG. 3 is an illustrative implementation of an example format suitable for implementing a process for non-gaming on-line achievement awards.

FIG. 4 is a flow diagram illustrating an implementation of a process for non-gaming on-line achievement awards.

FIG. 5 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, and articles of manufacture are disclosed herein that may be used to facilitate or support one or more processes or operations associated with non-gaming on-line achievement awards that may be implemented, partially, dominantly, or substantially, in or with information or award management systems. As will be described in greater detail below, on-line achievement awards may be utilized, in whole or in part, to provide behavioral incentives in a non-gaming setting, such as, for example, in connection with one or more non-gaming user accounts so as to increase user engagement, strengthen user loyalty, etc. by compelling or otherwise encouraging users to perform particular on-line activities or actions, steer users into desired on-line functionalities, or the like. As used herein, “non-gaming user on-line account” or simply “non-gaming account” may refer to an established relationship (e.g., via a registration, subscription, logging-in, identification, authentication, etc.) between a particular user and an on-line service provider, network, system, server, computer, operator, or the like, password-protected or otherwise, having a username, user profile, preferences, or like configurations uniquely identifying such a user for any purpose (e.g., participating in an achievement scheme, content creating or posting, searching, blogging, communicating, researching, shopping, etc.) except for a sole purpose of playing games (e.g., on-line, etc.). For example, a non-gaming account may be established or created by a user, which may also be referred herein to as “client,” with respect to an on-line system associated with a particular service provider, such as Yahoo!® (e.g., www.yahoo.com) allowing such an account to be authenticated or otherwise authorized to participate in an achievements scheme in connection with accessing system services including, for example, one or more on-line properties, as described below. In one particular implementation, at or upon establishing a non-gaming account, a user may create a unique electronic user profile, for example, via a client server process by entering appropriate information related or attributed to a user, such as, for example, user's screen name, e-mail address, location, password, preferences, or the like, though claimed subject matter is not so limited.

An “on-line property” or “property,” as the terms used herein, may refer to a domain-based or domain-specific collection of on-line information or resources provided by or having a family or affiliation-type relationship with a particular service provider and organized or otherwise grouped together by category, topic, theme, format, activity, or like concepts. As a way of illustration, a service provider, such as, for example, Yahoo!® (e.g., www.yahoo.com) may feature one or more on-line properties (e.g., on a portal page, etc.) that may typically, although not necessarily, comprise separate domains or sub-domains, such as Yahoo!® Search (e.g., http://search.yahoo.com), Yahoo!® Mail (e.g., http://mail.yahoo.com), Yahoo!® News (e.g., http://news.yahoo.com), Yahoo!® Sports (e.g., http://sports.yahoo.com), Yahoo!® Finance (e.g., http://finance.yahoo.com), Yahoo!® Answers (e.g., http://answers.yahoo.com), etc., just to name a few examples. As will also be seen, on-line properties may be enabled or otherwise supported by one or more special purpose computing platforms or servers (e.g., back-end, etc.), dedicated or otherwise. Generally, on-line properties may be presented (e.g., to a user, etc.) in a unified way, such as, for example, via a dynamic compilation of relevant or useful hyperlinks, selectable tabs, icons, etc. listed in a main portal or home page of a service provider, just to illustrate one possible implementation. In certain implementations, on-line properties may form, for example, a network of related or interrelated web sites, web pages, portal pages, home pages, or like electronic documents, centrally-managed or otherwise. Of course, these are merely examples relating to on-line properties, and claimed subject matter is not limited in this regard.

As was indicated, non-gaming on-line achievement awards may be implemented, partially, dominantly, or substantially, in the context of one or more on-line achievement schemes allowing users to achieve something in terms of quantity as well as quality, represented by one or more achievements, for example, that may serve as a reputation mechanism outside of an immediate gaming setting or paradigm. As used herein, “achievement,” “achievement scheme,” or the plural form of such terms may be used interchangeably and may refer to a conceptual model or operation of setting and attaining certain goals or objectives that may be realized, for example, via a family (e.g., theme, topic, or type-based, etc.) or program of awards or collectible features (e.g., achievement points, trophies, badges, etc.) reflecting successful user participation in one or more non-gaming activities (e.g., on-line, etc.) that require a certain level or amount of user skill, effort, training, knowledge, luck, or any combination thereof, rather than mere repetitious activity. For example, successful user participation may include choosing a certain goal or objective from a public list of overt or available achievements (e.g., skill-based, knowledge-based, etc.) presented or displayed to a user in some manner (e.g., in a user profile page, main portal or home page, on-line property page, etc.). As a way of illustration, an achievement may comprise, for example, getting a user's answer selected as the best answer (e.g., in the Yahoo!® Answers property, etc.) or an image or picture chosen as the most interesting (e.g., in the photo annotation corpus Flickr®, etc.), just to illustrate a few possible examples.

In an implementation, a list of available or attainable achievements may be hidden or otherwise include covert achievements, for example, such that a user may be awarded by “stumbling” (e.g., happily, unexpectedly, luckily, etc.) upon such one or more achievements while performing certain on-line actions or activities. To illustrate one possible implementation, a user may be alerted or notified in some manner (e.g., via a pop-up window, user profile page, main portal page, on-line property page, e-mail, etc.) that certain covert awards (e.g., of achievement points, etc.) are available or attainable by performing unspecified actions or activities in connection with a particular on-line property, such as Yahoo!® Search (e.g., http://search.yahoo.com) or Yahoo!® Answers (e.g., http://answers.yahoo.com), for example. Accordingly, being aware of such a possibility (e.g., of an achievement, etc.), a user may perform (e.g., unknowingly, unexpectedly, etc.) a particular qualified action or activity, such as, for example, searching for a trending topic, using Boolean operators (e.g., Britney OR Gaga, cake AND eat AND too, etc.), writing a first movie review, posting a one-hundredth recipe, being a one-millionth visitor, etc. and may be rewarded thereon (e.g., via achievement points, badges, etc.). It should be noted that in certain implementations a user may not be notified (e.g., in advance, etc.) with respect to one or more covert achievements and may “stumble” upon or otherwise attain such achievements by performing, for example, one or more unanticipated yet qualifying actions (e.g., skill-based, knowledge-based, etc.). Such actions may include, for example, doing something in a way a user might not have done or thought of before, using an approach that users might not typically use, just to name a few examples. It should also be appreciated that an achievement scheme may comprise, for example, any suitable or desired number of overt awards (e.g., of achievement points, etc.), covert achievements (e.g., of achievement points, etc.), or any combination thereof.

In addition, it should be understood that achievements, like some or most reputation mechanisms, may not be universally applied, meaning that not every user may be able to reach or attain certain achievements. For example, an achievement scheme may comprise a suitable combination of difficulties so as to provide a desirable synergy of challenges to stimulate a user into “thinking outside the box” or going outside of a user's “normal element,” into acquiring a particular skill, doing something unusual or not directly related to a particular on-line property, objective, or the like. As a way of illustration, in certain implementations, achievements may be structured, for example, to include a certain hierarchy where particular features, collectible or otherwise (e.g., achievement points, trophies, badges, on-line gadgets, controls, authorizations, etc.), may be collected, “unlocked,” granted, etc. progressively depending or based, at least in part, on an achievement level. For example, a user may need to obtain or acquire a certain amount (e.g., via specific point value, status, etc.) of knowledge, skills, etc. before progressing or advancing to the next achievement level (e.g., higher, more difficult to attain, etc.) and, as such, may not reach or attain certain achievements without a “pre-requisite,” required, etc. amount of knowledge, skills, etc.

In certain implementations, a user's progression in terms of achievement levels may be tracked in some manner using one or more collectible features or awards that may comprise, for example, one or more achievement points, badges, trophies, statuses, or the like. Accordingly, one or more next-level achievements may be “unlocked” or recommended based, at least in part, on a particular achievement level. For example, a list of more difficult yet more valuable achievements (e.g., with a higher point value, status, etc.) may be recommended (e.g., displayed, etc.) to a user as such a user attains lesser-difficulty or lesser-value achievements in order to encourage further user participation. It should be noted that some achievements may be relatively easy to attain or reach, for example, and gradations in terms of difficulty of achievements may be exponential or otherwise nonlinear, with each successive level of achievements being more difficult to reach or attain than a previous level. Also, certain achievements may be attained, for example, by accomplishing a group of goals or objectives or by collecting a group of particular collectible features, such as a group of property-related, knowledge or skill-based awards, etc., just to illustrate another possible implementation. By way of non-limiting example, a “Search Expert” award or status may be attained or achieved by successfully completing a certain number of search-related challenges (e.g., finding the best five pages for a particular query, etc.) or collecting a certain number of search-related awards (e.g., five, ten, etc.), thus, demonstrating an efficiency, proficiency, quality, etc. in performing on-line searches. Of course, these are merely examples relating to various achievements, points, awards, etc. and claimed subject matter is not limited in this regard.

As previously mentioned, certain on-line users (e.g., of service providers, on-line properties, etc.), members of on-line virtual communities (e.g., social networks, etc.), or the like may respond to opportunities to win or earn on-line collectible features or awards, such as achievement points, trophies, badges, etc. that may be collected or displayed, for example, to such a user or a group of on-line users, community members, or the like. These collectible features may serve, for example, as a reputation mechanism reflecting or representing a social evaluation or opinion in terms of an image, status, etc. towards a particular user by assessing and displaying a user's skills, knowledge, etc. as a proof of merit, aptitude, capacity, ability, talent, etc., which may give a user a sense of accomplishment. Thus, as will be described in greater detail below, non-gaming on-line achievement awards may be utilized, partially, dominantly, or substantially, to provide, for example, behavioral incentives by rewarding particular on-line actions or activities that may increase user engagement, strengthen user loyalty, or the like. For example, an on-line service provider may wish to encourage certain users to explore a range of its on-line product offerings, such as new or under-utilized features (e.g., associated with on-line properties, etc.) that may be unknown or otherwise may not appeal to such users, or to encourage more extensive use of popular features (e.g., to create a “buzz,” etc.). As another example, an on-line service provider may wish to educate users with respect to one or more features or functionalities (e.g., newly introduced, developed, tested, promotional, etc.) in connection with one or more on-line properties, for example, as part of a marketing campaign. Accordingly, an on-line service provider may attach awards of one or more achievement points, etc., hierarchically-structured or otherwise, to such new, underutilized, popular, educational, etc. features or functionalities, for example, as behavioral incentives and may reward participating or responding users. By way of non-limiting example, an on-line service provider may reward a user for successfully completing a teaching session, lesson, or tutorial in connection with certain features or functionalities and may show off or display the reward to other members of the user's network to draw their attention, provoke curiosity, etc., though claimed subject matter is not so limited. Thus, by rewarding users who utilize particular features, or by displaying user accomplishments, or by alerting users to the fact that rewards for activities indicative of thoughtful interaction with an on-line property (e.g., rather than mere repetitious activity, etc.) are available, an on-line service provider may encourage users into desired behaviors, steer users into desired on-line functionalities, build or strengthen user loyalty, or the like.

Also, in certain implementations, as an optional or alternative motivational factor or incentive, one or more collectible features, such as achievement points, badges, etc. with a specific point value, for example, may be redeemed, exchanged, or otherwise “cashed in” (e.g., in a non-monetary or monetary sense via coupons, discounts, etc.) for something tangible or intangible, functional, exclusive, personalized, fun, etc. that otherwise may not be available for all users (e.g., privileges, benefits, etc.). For example, a user may “buy” special rewards, such as an early access to a “beta” or improved version of an on-line property, new or personalized themes or features, special or personalized images in a user's likeness (e.g., avatars for messenger icons, etc.), account upgrades that “unlock” a special achievement, trophy, or feature, or the like. In addition, as was indicated, a user with an achievement with a qualifying point value may be given a status of an “expert” (e.g., in a particular subject, topic, or field, in connection with a particular on-line property, etc.), for example, allowing such a user to provide feedback on certain features (e.g., newly introduced, developed, tested, etc.) and, as a result, earn additional or special (e.g., “expert,” etc.) points. These redeemable or exchangeable points, privileges, benefits, goods, services, transactions, payments, etc. may be offered, provided, realized, fulfilled, etc., for example, by one or more on-line properties, participating providers of goods or services, or like entities associated, directly or indirectly, with one or more service providers, on-line properties, achievement schemes, etc. Of course, these are merely examples to which claimed subject matter is not limited.

Accordingly, as illustrated in example implementations described herein, one or more non-gaming accounts in connection, for example, with a particular service provider may be established or created. One or more achievement points based, at least in part, on actions or activities performed by one or more users associated with established non-gaming accounts may be allocated. As previously mentioned, allocated points may correlate or correspond to, be represented by, or otherwise be associated with, for example, one or more collectible features that may be displayed to a particular user or a group of users, if desired. As will be seen, a user may, for example, display or make some or all collectible features public (e.g., in a user's “vitality stream,” etc.) or, optionally or alternatively, may restrict showing or displaying some or collectible features to selected users, for example, by utilizing appropriate settings, filters, controls, or like features that may be provided by an on-line property or service provider.

As will be described in greater detail below, an immediate, instant, or real-time notification or feedback indicative of a particular achievement, such as an award with a specific point value, for example, may be provided when a user performs a qualifying action, activity, or otherwise interacts with an on-line property in a desired manner or in accordance with an achievement scheme. As used herein, “real time,” “immediate,” or “instant” may refer to amount of timeliness of data or information which has been delayed by an amount of time attributable to electronic communication or automatic information or data processing. As will be seen, such a notification may be provided, for example, in the form of an on-screen pop-up window, fade-in, icon, badge, etc. denoting or reflecting certain user qualifications, accomplishments, statistics (e.g., achievement points, titles, levels, user status, progress, etc.), or like information that may be displayed to a user or group of users in a “vitality stream” (e.g., activity or news sharing feed, etc.), just to illustrate one possible implementation. Optionally or alternatively, such a notification may be provided in the form of an electronic message (e.g., e-mail, text message, etc.) sent to a user (e.g., immediately, instantly, at or upon attaining an achievement, etc.), for example, to notify of or confirm an achievement.

As used herein, “immediate feedback” or “instant feedback” may be used interchangeably and may refer to a real-time-based process or operation of accounting for or providing evaluative, quantitative, qualifying, identifying, statistical, communicative, instructive, explanatory, or like information (e.g., to a user, group of users, etc.) in connection with displaying one or more collectible features based, at least in part, on one or more qualifying actions, activities, performances, etc. of a user (e.g., associated with an on-line non-gaming account, etc.) resulting in an award of one or more achievements, such as trophies, badges, points, etc. or otherwise facilitating or supporting a particular achievement scheme. For example, as will be described in greater detail below, a user may perform a particular action (e.g., a Boolean search, etc.) in a manner that triggers or fulfills an achievement requirement. Accordingly, an award (e.g., of achievement points, etc.) may be accounted for or brought to the attention of such a user or a group of users (e.g., via a pop-up window, etc.) via an immediate feedback, for example, such as simultaneously with or immediately subsequent to performing a qualifying action, rather than at the end of a user on-line session, day, etc. Thus, immediately alerting a user to the fact that the user attained or earned a specific achievement may encourage continued user participation or provide, for example, an incentive or motivation to pursue other activities leading to various attainable achievements (e.g., next achievement level, badge, trophy, etc.).

As will also be seen, an achievement scheme may be applied uniformly or in a substantially unified way, for example, such as via a consistent use of certain structural, functional, etc. features or elements. To illustrate, in an implementation, an achievement scheme may be applied across one or more on-line properties associated, for example, with a particular service provider so as to facilitate or support a consistent look and feel or create a sense of structural or functional cohesiveness or connectivity between or among on-line properties. For example, a user may navigate, switch between, or otherwise use multiple on-line properties (e.g., during a session(s), etc.), and certain collectible features, access controls, operations, processes, procedures, content, or like information or functionalities may be sufficiently correlated, integrated, aggregated, computed, accounted for, etc. so as to “follow” such a user or otherwise consistently or cohesively “flow” throughout different on-line properties (e.g., spanning multiple domains, sub-domains, etc.). As a way of illustration, achievement points may be accounted for or displayed (e.g., via immediate feedback, etc.), for example, in connection with uniformly-shaped pop-up windows, fade-ins, badges, etc. having like design, shape, color, fonts, layout, size, orientation, etc. so as to ensure consistency or cohesiveness in accounting, presentation, operation, content, appeal, or the like throughout one or more on-line properties. As such, users may likely have a unifying sense of a structural as well as functional predictability with clearer graphical continuity or cohesiveness in connection with an achievement scheme applied across different on-line properties associated with a service provider, social network, etc. Accordingly, such a logical consistency may allow users to recognize a unifying structure and concentrate on particular tasks, actions, objectives (e.g., achievements, etc.) rather than getting re-oriented to a new visual environment while navigating between different on-line properties. This may provide a more satisfying user experience, thus, leading to an increased user engagement (e.g., usability of a search engine, etc.) or stronger user loyalty, for example. Optionally or alternatively, an achievement scheme may not be applied uniformly or one or more collectible features, operations, processes, procedures, etc. may be personalized or tailored with respect to a particular on-line property or a user. Of course, such details relating to applying an achievement scheme are merely examples, and claimed subject matter is not so limited.

As previously mentioned, an achievement scheme may, for example, be implemented, partially, dominantly, or substantially, for use in or with one or more on-line properties, such as, for example, a search engine-based on-line property associated with a particular service provider, though claimed subject matter is not so limited. Before describing some examples methods, apparatuses, or articles of manufacture in greater detail, sections below will first introduce certain aspects of an implementation of an example computing environment associated with an example on-line property, such as, for example, an on-line search-based property in which non-gaming on-line achievement awards may be advantageously utilized. It should be appreciated, however, that techniques provided herein and claimed subject matter are not limited to this example implementation. For example, techniques provided herein may be adapted for use in a variety of information processing environments associated with various on-line properties, such as on-line auction or advertisement (e.g., sponsored, targeted, contextual, etc.) management systems, on-line electronic exchange or database applications, on-line behavioral or transaction models (e.g., web-browsing habit or behavior tracking in connection with achievements, user feedbacks, topic-based reviews, etc.), or the like. In addition, any implementations or configurations described herein as “example” are described herein for purposes of illustrations and are not to be construed as preferred or desired over other implementations or configurations.

The World Wide Web, or simply the Web, may comprise a vast array of information accessible worldwide and may be considered as an Internet-based service organizing information via use of, for example, hypermedia (e.g., embedded references, hyperlinks, etc.). As such, it may be desirable to provide, for example, a convenient or effective point of access or pathway to various Internet-based resources. For example, a service provider may help a user to conveniently locate, retrieve, browse, access, organize, etc. information of interest by utilizing one or more on-line properties associated with such a provider and tailored towards or grouped by a particular topic, category, service, goods, activity, or the like. As previously mentioned, on-line properties may be represented by, for example, a network of related or interlinked web sites, web pages, portal or home pages, or like electronic documents, centrally-managed (e.g., by a service provider, etc.) or otherwise (e.g., personal portals, etc.). A “document,” “web document,” or “electronic document,” as the terms used herein, are to be interpreted broadly and may include one or more stored signals representing any source code, text, image, audio, video file, or like information that may be read by a special purpose computing apparatus and may be played or displayed to a user. Documents may include one or more embedded references or hyperlinks to images, audio or video files, or other documents, as previously mentioned. For example, one type of reference that may be embedded in a document and used to identify or locate other documents comprises a Uniform Resource Locator (URL). As a way of illustration, documents may comprise an on-line property, social network, blog post, e-mail, text message, an Extensible Markup Language (XML) document, a web page, a media file, a page pointed to by a URL, just to name a few examples.

Considering an overabundance of resources available on the Web, an on-line service provider, such as Yahoo!®, for example, may feature one or more search engine-based or search engine-supported on-line properties (e.g., Yahoo!® Search, available at http://search.yahoo.com) to help users locate or retrieve information of interest associated with other on-line properties, Internet-based content, or other resources, though claimed subject matter is not so limited. Here, for example, a search engine-based or search engine-supported on-line property, which may herein be simply called a search engine, may comprise an interface, such as a graphical user interface (GUI). A query may be submitted via an input window associated with such a GUI, for example, by entering certain words or phrases to be queried, and a search engine may return a search results page, which may include a number of documents typically, although not necessarily, listed in a particular order. Under some circumstances, it may also be desirable for a search engine to utilize one or more processes to rank documents so as to assist in presenting relevant or useful search results in an efficient or effective manner. A search engine, thus, may employ a ranking function to rank documents estimated to be relevant or useful based, at least in part, on estimated relevance of these documents to a query. For example, a search engine may place documents with higher relevance in a higher position or slot on a returned search results page. In turn, documents with lower relevance may be placed in lower positions or slots among search results. A search engine user or client, thus, may receive and view a listing of search results presented, for example, in decreasing order of relevance, just to illustrate one possible implementation.

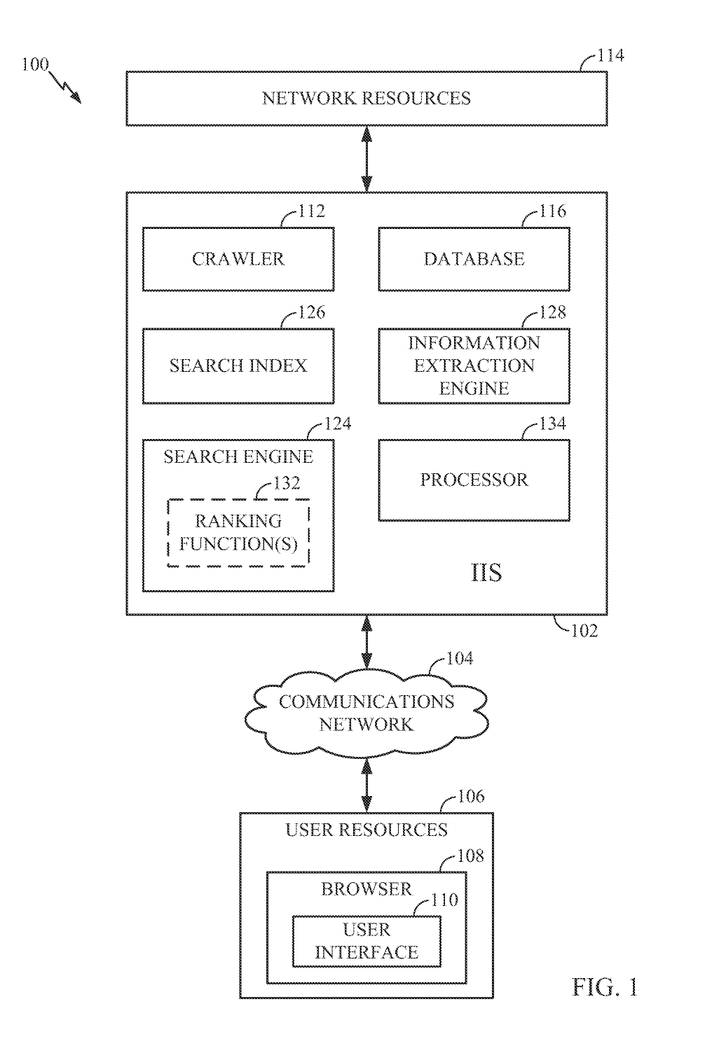

Attention is now drawn to FIG. 1, which is a schematic diagram illustrating certain functional features of an implementation of an example computing environment 100 that may operatively facilitate or support, in whole or in part, one or more processes associated with non-gaming on-line achievement awards, as will be seen. Example computing environment 100 may be operatively enabled using one or more special purpose computing platforms or apparatuses, information communication devices, information storage devices, computer-readable media, applications or instructions, various electrical or electronic circuitry and components, input information, etc., as described herein with reference to particular example implementations.

As illustrated herein, computing environment 100 may include an Information Integration System (IIS) 102 that may be associated with a service provider and may be operatively coupled to a communications network 104 that a user or client may employ in order to communicate with IIS 102 by utilizing resources 106. It should be appreciated that IIS 102 may be implemented in the context of one or more award or information retrieval or management systems associated with public networks (e.g., the Internet, the World Wide Web) private networks (e.g., intranets), Real Simple Syndication (RSS) or Atom Syndication (Atom)-based applications, etc., just to name a few examples.

Resources 106 may comprise, for example, any kind of special purpose computing device (e.g., mobile device, personal digital assistant, e-book reader or notepad, etc.) communicating or otherwise having access to the Internet over a wired or wireless network. Resources 106 may include a browser 108 and an interface 110 (e.g., a GUI, etc.) that may initiate a communication with IIS 102, such as, for example, a transmission of one or more electrical digital signals representing a query. Browser 108 may facilitate access to and viewing of documents over the Internet, for example, such as HTML web pages, pages formatted for mobile devices (e.g., WML, XHTML Mobile Profile, WAP 2.0, C-HTML, etc.), or the like. Interface 110 may comprise any suitable input device (e.g., keyboard, mouse, touch screen, digitizing stylus, etc.) and output device (e.g., display, speakers, etc.) for interaction with resources 106. Even though a certain number of resources 106 are illustrated in FIG. 1, it should be appreciated that any number of resources may be operatively coupled to IIS 102 via, for example, communications network 104.

In an implementation, IIS 102 may employ a crawler 112 to access network resources 114 that may include, for example, any organized collection of information, such as one or more on-line properties or other information accessible via the Internet, the Web, one or more servers, etc. or associated with one or more intranets. Crawler 112 may follow one or more hyperlinks associated with electronic documents and may store all or part of documents (e.g., URLs, etc.) in a database 116, for example. IIS 102 may further include a search engine 124 supported by an index, such as, for example, a search index 126 and operatively enabled to search for information associated with network resources 114. For example, search engine 124 may communicate with interface 110 and may retrieve and display a listing of search results associated with search index 126 in response to one or more digital signals representing a query. In one particular implementation, information associated with search index 126 may be generated by an information extraction engine 128, for example, based, at least in part, on extracted content of a file, such as an XTML file associated with a particular document during a crawl.

As was indicated, IIS 102 may employ one or more ranking functions, indicated generally in dashed lines at 132, to rank search results in an order that may be based, at least in part, on a relevance to a query. It should be noted that ranking function(s) 132 may be included, in whole or in part, in search engine 124 or, optionally or alternatively, may be operatively coupled to it. As illustrated, IIS 102 may further include a processor 134 that may be operatively enabled to execute special purpose computer-readable instructions or implement various processes associated with example environment 100. For example, processor 134 may be utilized, at least in part, to determine whether particular actions qualify a user for an award or to validate or verify achievements to prevent or reduce instances of user or client hacking, cheating, etc., just to illustrate one possible implementation.

In operative use, a user or client utilizing, for example, a search engine-based or search engine-supported on-line property may submit or input a query via resources 106. Browser 108 may initiate communication of one or more electrical digital signals representing a query from resources 106 to IIS 102 via communication network 104. IIS 102 may look up search index 126 and establish a listing of documents based, at least in part, on relevance according to ranking function(s) 132. IIS 102 may then communicate such a listing to resources 106 for displaying on interface 110.

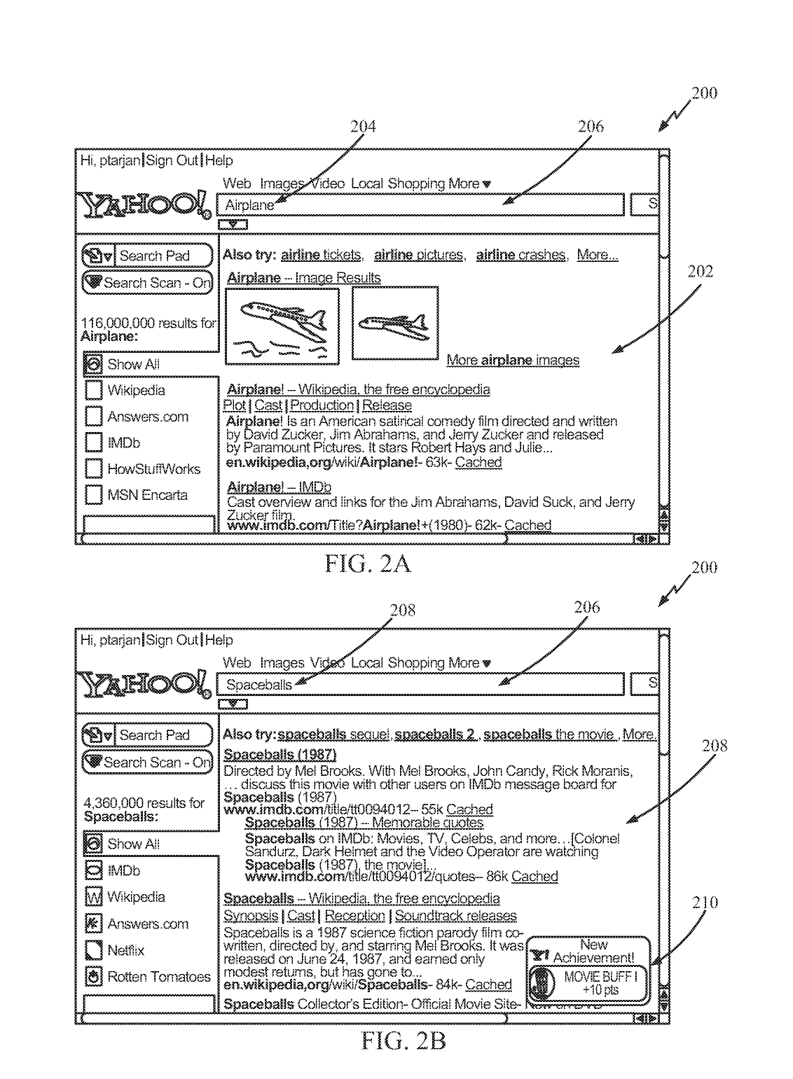

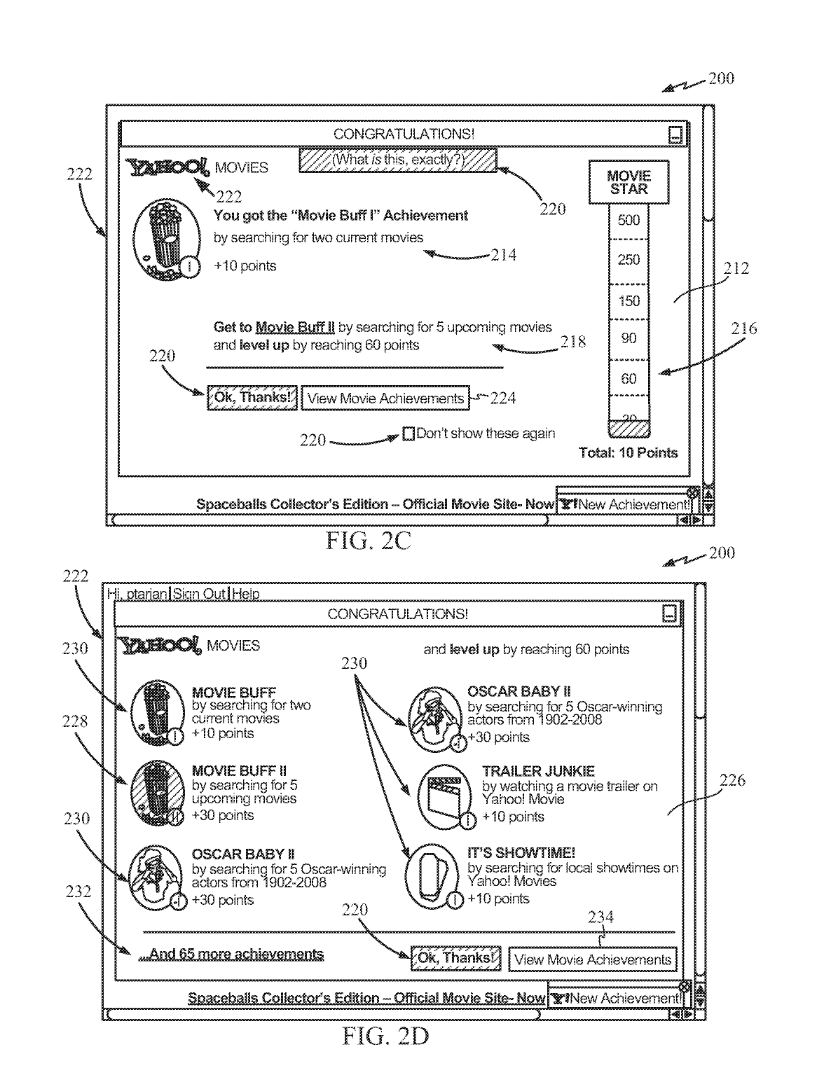

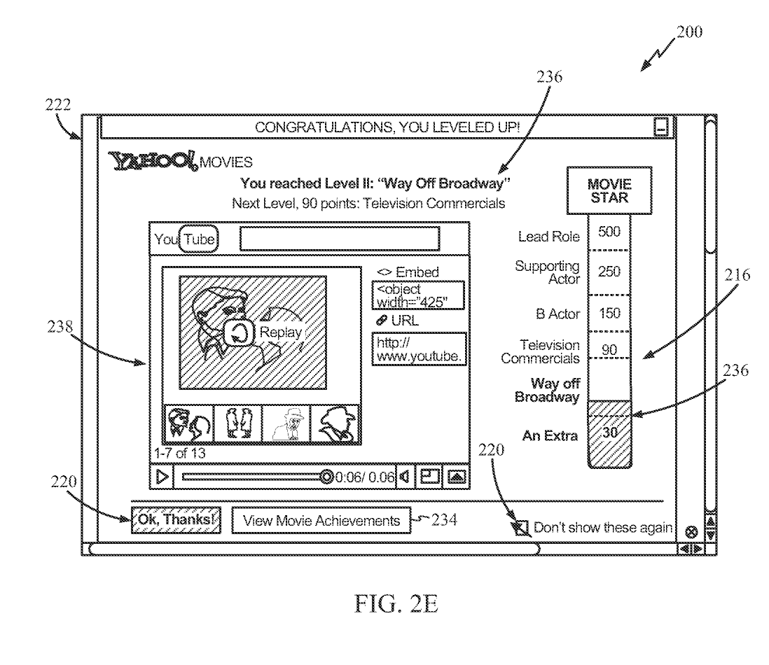

With this in mind, example techniques will now be described in greater detail that may be implemented, partially, dominantly, or substantially, to efficiently or effectively facilitate or support one or more processes associated with non-gaming on-line achievement awards. FIGS. 2A-2E are representations of screenshot views of an implementation of a user display 200 shown in connection with an achievement scheme associated, for example, with computing environment 100. These figures may illustrate an example progression of a user's interaction with a search engine-based or search engine-supported on-line property leading to one or more achievements in connection with a particular achievement scheme, though claimed subject matter is not limited to such an example progression, on-line property, or achievement scheme, of course. As seen in FIG. 2A, user display 200 may feature an on-line property, such as, for example, a search engine associated with a GUI in connection with a computing platform or server capable of to locating, retrieving, ranking, presenting, organizing, selecting, etc. one or more documents received in response to a query. An on-line property may be supported, for example, by any suitable technology or processes for on-line access, interaction, or communication of a user or client with a special purpose computing platform or server associated with an on-line service provider, as will be described in greater detail below. Display 200 may be operated by a special purpose computing apparatus, such as, for example, a desktop computer, a notebook, a laptop computer, or other special purpose computing device or platform that may be enabled to access, interact, or communicate with one or more on-line properties via an electronic network, such as, for example, LAN, WAN, the Internet, etc.

As used herein, GUI may refer to a program interface that utilizes displayed graphical information to allow a user or client to control or operate a special purpose computing platform by a pointer or a pointing device. A pointer may refer to a cursor, arrow, or other symbol that may appear on display 200 and may be moved or controlled with a pointing device to select or populate fields or input commands via a GUI of a special purpose computing platform. A pointing device may refer to any device used to control a cursor or arrow, to select objects, to populate fields, or to input information. Such pointing devices may include, for example, a mouse, a trackball, a track pad, a track stick, a keyboard, a stylus, a digitizing tablet, or similar types of devices. A cursor may refer to a symbol or a pointer where an input selection or actuation may be made with respect to a region in a GUI. Here, terms such a “click” or “clicking” may refer to a selection process made by any pointing device, such as a mouse, for example, but use of such terms is not intended to be so limited. For example, a selection process may be made via a touch screen of a tablet PC, mobile communication device, portable navigation device, etc., wherein “clicking” may comprise “touching.” However, it should also be noted that these are merely examples relating to selecting documents or inputting information, such as one or more queries, and claimed subject matter is not limited in these respects.

In this illustrated example, a foreground of display 200 may feature a listing of search results 202 returned in response to a query 204, such as the query “Airplane,” for example, inputted or submitted by a user. Such a query may be inputted into an input field or window 206 provided by a GUI, for example, just to illustrate one possible implementation. As seen, a GUI provided by an on-line property may also include various selectable fields, toolbars, scroll bars, hyperlinks, images, icons, or other selectable or visual content providing an ergonomic, efficient, or interactive user environment to which claimed subject matter is not limited. During a session, a user may input or submit another (e.g., a second, consecutive, etc.) query, as illustrated at 208 in FIG. 2B, such as the query “Spaceballs,” for example, to try to locate relevant or useful documents, which may be represented herein by a listing of returned search results 208. Here, as a result of two sequential movie-related searches, a pop-up or fade-in window 210 may appear on display 200, for example, notifying or alerting a user to a new achievement “MOVIE BUFF I” and accounting for 10 achievement points. As previously mentioned, a user may be notified or points may be accounted for based, at least in part, on an immediate feedback, such as, for example, simultaneously with or immediately subsequent to performing a qualifying action or operation (e.g., inputting or submitting the second movie-related query “Spaceballs,” etc.). Of course, this is merely an example, and claimed subject matter is not so limited.

It should be noted that even though pop-up or fade-in achievement window 210 is illustrated on a particular portion of display 200, such a window or other suitable or desirable content may be displayed on any portion of display 200 or, optionally or alternatively, may not be displayed at all. For example, a user may be notified or alerted to an achievement via an electronic communication (e.g., e-mail, text message, etc.) sent to a user's non-gaming account (e.g., immediately, instantly, at or upon attaining an achievement, etc.), as was previously indicated. Also, a user may select or choose preferred or desired means of achievement notification (e.g., pop-up window, fade-in, e-mail, etc.) or using, for example various features or controls that may be provided by a GUI associated with a particular on-line property. In addition, achievement window 210 may be partially or substantially customizable (e.g., changeable by a user, client, provider, etc.) in terms of design, layout, appearance, position, orientation, or the like. In one particular implementation, after a certain amount of time (e.g., 5, 10 seconds, etc.), for example, window 210 may disappear, in whole or in part, from display or a part of display 200 (e.g., drop down, slide or move aside, etc.). Optionally or alternatively, a user may move, resize, zoom, minimize, maximize, or close window 210 by operating appropriate controls, such as clicking on an “X” button to close the window or by placing an arrow pointer over window 210 to restore the window (e.g., a “mouse-over,” tooltip, etc.), for example. Various user interactions or manipulations, GUI event-driven or otherwise, with on-screen or off-screen information or content are known and need not be described here in greater detail. Also, whether subsequent information fields are originated or displayed progressively may depend, at least in part, on a user's previous selection of available options or an application, for example. Of course, these are merely examples, and claimed subject matter is not so limited.

FIG. 2C is a representation of a screenshot view of an information window 212 that may appear on user display 200, for example, if a user clicks on pop-up or fade-in window 210 of FIG. 2B, just to illustrate one possible implementation. As seen, information window 212 may include one or more information fields providing details about a particular achievement. Such information may, for example, be generated, accounted for, tracked, communicated, or stored with reference to a particular non-gaming account, at least in part, by a special purpose computing platform or server associated with an on-line service provider (e.g., centrally-managed, etc.) or a particular on-line property (e.g., dedicated, etc.). Here, achievement information may comprise, for example, an information field 214 that includes a title of an achievement or user status (e.g., “Movie Buff I,” etc.), actions that qualified user for an achievement (e.g., searching for two current movies, etc.), a number of allocated achievement points (e.g., 10, etc.), and an achievement-related logo, icon, image, etc. Information window 212 may further include a visual indicator or progress bar tracking a user's progression in terms of achievement levels or points, such as a level-up meter 216 realized herein, for example, as a “movie-star thermometer” indicating a total number of achievement points that a user reached or attained (e.g., 10, etc.), as well as a number of points (e.g., 500, etc.) required to achieve a “collect-them-all” achievement or meta-award (e.g., “Movie Star,” etc.). As seen, information window 212 may also comprise, for example, an information field 218 that includes a recommendation with respect to a next attainable achievement (e.g., getting to “Movie Buff II” by searching for 5 upcoming movies, etc.) so as to encourage further user participation, as previously mentioned. Information window 212 may also include various interactive features, elements, or controls, (e.g., check boxes, selectable tabs, hyperlinks, etc.), indicated generally at 220, allowing a user to indicate or communicate one or more preferences, decisions, etc. or to navigate to reference or supporting information in connection with an achievement scheme. In addition, information window 212 may include a branding field 222, which may comprise a name, description, logo, icon, or any combination thereof. For example, branding field 222 may comprise a logo or image that represents a particular on-line property, service provider, or the like (e.g., Yahoo!® Movies, etc.). Again, such details are merely examples, and claimed subject matter is not so limited.

As previously mentioned, a user may view a list of available or attainable achievements in connection with one or more on-line properties, for example, resulting from clicking on or selection of a tab 224, just to illustrate one possible implementation. As a result, and as shown in FIG. 2D, a new window 226 may appear in display 200 that may show, for example, a list of hierarchically or progressively-structured achievements, though claimed subject matter is not so limited. As a way of illustration, window 226 may comprise, for example, one or more available or attainable achievements, such as a next level achievement 228 (e.g., “Movie Buff II,” etc.), which may be emphasized or highlighted in some manner to indicate its availability. As seen, achievement 228 may include an achievement-related logo or image and may indicate user's qualifying actions leading to such an achievement (e.g., searching for 5 upcoming movies, etc.), as well as a number of achievement points that may be allocated or gained (e.g., 30, etc.) by reaching achievement 228. In addition, one or more “locked” or otherwise unavailable achievements (e.g., higher level, etc.), shown generally at 230, may be displayed or presented to a user in a “grayed-out” fashion so as to let such a user know that they cannot currently be attained or selected. As was indicated, displaying “locked” achievements, such as achievements 230, for example, may encourage continued user participation, provide an incentive or motivation to pursue activities leading to these achievements, or otherwise provoke user curiosity. “Grayed-out” or “locked” achievements may also provide achievement-related information, such as, for example, recommendations or ways for attaining or reaching an achievement, points to be allocated, title or user status, or the like. Also shown, and which may prompt a user's selection, if desired, a hyperlink 232 allowing a user to view other potential achievements (e.g., available, attainable, “locked,” covert, hidden, etc.) and a selectable button or tab 234, which may bring up or otherwise display in some manner all achievements attained or reached by a particular user in connection with one or more on-line properties. It should be appreciated, however, that details in connection with a display or associated windows are merely illustrative examples, and that claimed subject matter is not limited in this regard.

As was indicated, collected achievement points or like features reaching, for example, a specific point value may be redeemed, exchanged, etc. for something tangible, intangible, functional, exclusive, personalized, fun, etc., such as, for example, a particular reward or benefit that may not otherwise be available for all users. In one particular implementation, a reward may comprise, for example, a trailer of an upcoming movie or a video clip of a newly released song, as illustrated in FIG. 2E, though claimed subject matter is not so limited. As seen in this illustrated example, a user has leveled up or attained the “Way off Broadway” level or status, as indicated generally by arrow at 236, which qualified such a user for a movie trailer or clip 238, just to illustrate one possible implementation. It should be noted that various types of rewards or benefits may be available in connection with a particular achievement scheme. For example, a reward may comprise a listing of memorable or notable quotes from famous or prominent authors, poets, etc. (e.g., in connection with searching for books, authors, etc.) or a coupon or branded gift card redeemable in certain on-line shopping sites, or the like. It should also be appreciated that visual indicators in connection with a user's progression or level, such as a progress bar or level-up meter 216, as well as other content associated with display 200, may be customizable (e.g., by a user, client, on-line property or service provider, etc.) including, for example, progression steps, achievement point integers, titles, names, statuses, descriptions, layouts, icons, or the like.

In an implementation, certain achievements (e.g., with a specific achievement point value, achievement level, status, etc.) may be awarded or rewarded with or otherwise be represented by, for example, one or more badges or trophies (e.g., virtual, etc.) as was previously indicated. For example, a badge may be associated with a particular on-line property or a group of on-line properties and may serve as a form of recognition marking or otherwise indicating a particular achievement reached or attained by a user. As a way of illustration, a badge may comprise an image, icon (e.g., badge or trophy-shaped, etc.), or like artistic rendering along with an inscription, legend, or other achievement-related information, which a user may keep on a “virtual display” or “Trophy Case” (e.g., on a user profile page, etc.), for example, for a particular user or a group of users (e.g., members of a network, authorized or trusted users, close friends, etc.) to see. It should be noted that a user may display or make some or all badges or other collectible features public (e.g., in a “vitality stream,” etc.) or, optionally or alternatively, may restrict showing or displaying some or all badges or other collectible features to selected users, for example, by utilizing appropriate settings, filters, controls, or like features that may be provided by an on-line property or service provider.

In certain implementations, a badge may be assigned or ascribed to or be associated with a particular badge landing page or pad, designated or otherwise, presenting or displaying information relevant to such a badge. Optionally or alternatively, a badge may employ a lightbox-type feature utilizing any suitable re-sizing application, such as, for example, an application that may facilitate or support displaying of a magnified or larger-sized rendition of a badge using one or more gliding animation features (e.g., re-sizing without leaving a page, etc.), if a user clicks on such a badge, though claimed subject matter is not so limited. As a way of illustration, a badge landing page may comprise, for example, an icon of badge-like appearance along with a title or legend, description of qualified actions, specific point value associated with a badge, or other related information. For example, a badge landing page may comprise information related to a “pre-requisite” or lower-level badge (e.g., a child badge, etc.) required to earn or attain in order to progress to or be eligible for a successive or a higher-level badge (e.g., a parent badge, etc.). Also, a badge landing page may comprise certain social network-related information, such as names of one or more members of a user's network, for example, who have recently earned that particular or related badge. In addition, a badge landing page may comprise status information as to whether a user has—or has not—earned a particular badge or information in connection with a user's progression (e.g., via a visual indicator, progress bar, etc.) towards earning a particular badge (e.g., attained fifty out of one hundred points necessary, etc.). Of course, such details relating to badges or badge landing pages are merely examples, and claimed subject matter is not limited in this regard.

In an implementation, an on-line service provider or property may feature or render a global (e.g., spanning one or more social networks, etc.) or personalized (e.g., local, within a user's network, etc.) leaderboard so as to display or present, for example, names (e.g., screen names, IDs, aliases, etc.) of leading users that may be ranked in some manner (e.g., from highest to lowest, etc.) in accordance with a particular achievement scheme. For example, a leaderboard may include a list comprising a fixed number of top-performing users or leaders in connection with a particular category, topic, on-line property, etc. and may typically, although not necessarily, provide multiple views with respect to one or more achievements (e.g., all-time or overall standings, weekly or daily standings, last hour “movers and shakers,” etc.), just to illustrate one possible implementation. A leaderboard may also allow users to browse or view, for example, profiles or badge landing pages of best performers or leading users, if desired, though claimed subject matter is not limited in this regard, of course. In one particular implementation, instead of a global leaderboard, a local or personalized leaderboard may be employed (e.g., by a service provider, on-line property, etc.) so as to prevent or reduce instances of hacking into, cheating, or otherwise gaming the system (e.g., to keep a rank, position, etc.), which may, for example, discourage participation or dilute the value of achievements. Accordingly, a local or personalized leaderboard may feature or display users who may be friends, acquaintances, or otherwise be familiar with each other in some fashion, which may eliminate or lower a desire, pressure, etc. to hack into, cheat, or otherwise game the system, for example.

As previously mentioned, one or more processes or operations associated with non-gaming on-line achievement awards may be facilitated or supported, at least in part, by a one or more special purpose computing platforms or apparatuses. For example, in an implementation, such one or more special purpose computing platforms or apparatuses may comprise, at least in part, a client-server system or network in which one or more special purpose computing platforms associated with a particular service provider, which may herein be called simply servers, may operate as a hub serving one or more special purpose client devices, which may herein be called simply client devices. It should be appreciated that there may be no single type of a client device with which a user or a group of users may choose to access one or more on-line properties associated with a service provider. Users may, for example, utilize various types of client devices that may have a variety of resident or add-on applications including a network browser or similar application capable of interacting with information located on or associated with a network (e.g., one or more servers, etc.). A client-server system or network may use, for example, an extensible markup language (XML) or other suitable formats, XML-based or otherwise, such as HyperText Markup Language (HTML), Extensible Hypertext Markup Language (XHTML), etc. to communicate information among one or more client devices or servers. In one particular implementation, information, such as applications, files, or like electronic signals associated with a non-gaming on-line achievement awards may be encoded using a JavaScript™ type format, as explained below, though claimed subject matter is not so limited, of course.

A network may comprise, for example, any type of communications network, such as a local area network (LAN), a wide area network (WAN), the Internet, etc. capable of facilitating or supporting communications between one or more client devices and one or more servers such that one or more collectible features (e.g., achievement points, etc.) may be accounted for based, at least in part, on an immediate feedback to one or more non-gaming accounts, as was previously indicated. Accordingly, users may utilize various types of client devices, including a thin client computing device (e.g., laptop, notepad, etc.), a desktop computing device, a mobile phone, a personal digital assistant (PDA), or the like, just to name a few examples. It should be appreciated that despite a possibility of such a diversity of client devices or variety of varying resident platforms or applications (e.g., network browsers, etc.), an achievement scheme that maintains a user environment that is sufficiently consistent or coherent across multiple users is a desirable goal. As such, users participating in an achievement scheme may have the benefit, for example, of being able to utilize a client device of their choice, regardless of operating systems, platforms, applications, or capabilities.

In an implementation, an ability of a user to participate in an achievement scheme or otherwise interact with one or more on-line properties may be an advantage provided by a client-server system or network. For example, an application programming interface (API) provided by a host or server computer(s) may be used to support a GUI, network browser applications, etc. residing on or associated with one or more client devices. As such, a relatively seamless or coherent integration (e.g., visual, functional, etc.) may be possible between one or more varying client-based resident programs, different on-line properties, processes or operations (e.g., award presentation, user authentication, achievements validation or verification, etc.) or the like. For example, a browser-deployed application may facilitate or support user interaction with one or more on-line properties in connection with non-gaming on-line achievement awards relatively independently of hardware or software capabilities that may be available on client devices. Thus, a relatively small software load may be advantageously experienced by a thin client device, such as a notepad or PDA, for example, while one or more servers may carry a fuller load of multiple processes, operations, applications, services, or stored information. Accordingly, by shifting, partially, dominantly, or substantially, certain computing burdens to one or more servers, users may experience coherent or cohesive content presentation (e.g., across a number of on-line properties, etc.), easier navigation or content management, as well as various advantages of client-server operating or computing environment including centralized storage, backup, enhanced security (e.g., user authentication, achievements validation or verification, etc.), or the like. It should be noted that applications, files, or like electrical digital signals associated with an achievement scheme may be located separately or together on any portion of a client-server network or system, such as, for example, on a specific computing platform or a cluster of computing platforms. Of course, claimed subject matter is not limited in scope to employing this particular approach. Rather, a client-server network or system is merely provided as one example featuring capabilities as illustrated in example implementations described herein. Accordingly, many other approaches to providing similar or like capabilities are available, and claimed subject matter is not limited in scope to any particular approach.

As mentioned above, a user may choose to participate in an achievement scheme by creating or establishing a non-gaming account allowing such a user to log onto a client-server system, for example. As such, a resident browser application may be able to communicate with one or more servers on a network, such as one or more servers overseeing or managing one or more operations or processes in furtherance of an achievement scheme, for example, with reference to a user-ID associated with a non-gaming account accessed by such a client device. To illustrate, a client device may communicate with a server to request information with respect to one or more achievements in connection with one or more on-line properties after detecting one or more qualifying user actions, for example, or to receive information (e.g., validated or verified, checked, authorized, accounted, etc.) regarding a particular achievement to show or display, as described below. Information in connection with an achievement scheme may be communicated or stored, for example, with reference to a user-ID associated with a particular non-gaming account, as was also indicated. It should be appreciated that such information may be encrypted for security reasons. An encryption may be applied to all or part of such information and may include, for example, user ID, preference information (e.g., trusted network member IDs, etc.), permission information (e.g., access passwords, etc.), validation or verification information, awards-related information, or the like. It should also be noted that in certain implementations one or more processes or operations in connection with an achievement scheme may occur, partially, dominantly, or substantially, off-line, wherein a user need not be logged onto a client-server network or system, for example, to participate in an achievement scheme. Of course, such details regarding an achievement scheme are merely examples, and claimed subject matter is not limited in this regard.

Subsequently to a user's logging onto a client-server network or system, for example, one or more qualifying actions or activities of such a user in connection with an achievement scheme may be “listened” to (e.g., so as to detect, recognize, etc.), for example, by a network browser residing on a client device that may communicate such information to one or more servers associated with an on-line service provider, such as Yahoo!® (e.g., www.yahoo.com), just to illustrate one possible implementation. More specifically, an achievement may be triggered, for example, by one or more “events” (e.g., actions performed by a user one or more times, etc.) that may typically, although not necessarily, be detected by a suitable software, such as, for example, JavaScript™—type software based, at least in part, on a Mozilla Foundation™ source code or a modification of Mozilla Foundation™ source code running on a client device (e.g., a network browser, etc.). Optionally or alternatively, an event may be detected, for example, using one or more time-based job scheduling applications or software running (e.g., “listening,” etc.) periodically or at certain select times, such as a cron-driven or cron-supported software program (e.g., a cronjob, etc.) running on a suitable computing platform or server, dedicated or otherwise, just to illustrate another possible implementation.

In operative use, when a particular event occurs, for example, information related to such an event may be communicated to a server from a client device with a reference to a user ID associated with a particular non-gaming account, as was previously mentioned. Such information may include a detected or qualifying user action, associated on-line property or a group of on-line properties, a request to furnish achievement-related information, or the like, just to name a few examples. Optionally or alternatively, a client device may validate or verify an event in terms of correctness, integrity, availability, assurance, security, or the like before notifying a server, for example, so as to prevent or reduce instances of cheating, hacking into, or otherwise gaming the system. Such a validation or verification may comprise, for example, one or more processes or operations utilizing any suitable validation or verification rules, routines, or logic.

Continuing with the above example, information related to an event may be communicated to a server on a client-server network from a client device, for example, wherein the server may validate or verify the event. For example, a server may validate or verify whether an action qualifies a user for an achievement (e.g., in terms of correctness, integrity, availability, assurance, security, etc. of the action, etc.) using one or more suitable server-side processes or operations. Thus, a server-side validation may act as another (e.g., a second, third, etc.) validation or verification layer that is sufficiently independent of other validation or verification layers with respect to a client-server network or system, though claimed subject matter is not so limited. Subsequently to validation or verification as well as other operations or processes associated with non-gaming on-line achievement awards (e.g. accounting for achievement points, etc.), a network server may transmit instructions to a client device to display or present achievement-related information during, for example, an application of an achievement scheme. As was indicated, transmitted achievement-related information may comprise, at least in part, one or more achievement points, for example, accounted for with respect to a particular non-gaming account via an immediate feedback. Of course, this is merely an example to which claimed subject matter is not limited.

In an implementation, to facilitate or support one or more processes associated with an achievement scheme, suitable or desired information, such as, for example, events-related, achievements-related information, or the like may be given as input in the form of computer-readable code or instructions to be programmatically executed through any suitable sequence of operations. For example, although claimed subject matter in not limited in scope in this respect, one or more files, applications, or like electronic signals associated with a non-gaming on-line achievement awards may be encoded using a JavaScript™-type or similar format, as previously mentioned. By way of example but not limitation, in certain simulations or experiments, non-gaming on-line achievement awards were created using, at least in part, an information-oriented file, such as a YAML file describing one or more particular achievements and a JavaScript™—based file describing one or more qualifying events. Again, such details relating to non-gaming on-line achievement awards are merely examples, and claimed subject matter is not limited in this regard. It should be noted that a format may depend, at least in part, on particularities of various systems, environments, networks, etc. employed or utilized by a service provider, on-line property or a group of on-line properties, or like entity facilitating or supporting one or more processes or operations associated with an achievement scheme, for example. Techniques used in signal processing or related arts, for example, to facilitate or support one or more processes or operations pursuant to instructions from program software are known and need not be described here in greater detail.

By way of example but not limitation, one possible format suitable for implementing one or more processes or operations associated with non-gaming on-line achievement awards in connection, for example, with a user's registering or establishing a non-gaming account may include one represented in Table 1 below. Thus, consider:

TABLE 1
Example achievement format.

{“award”: [
{

“name”: “Welcome to the club”,
“url”: “http://metaward.com”,
“imageurl”: “http://metaward.com/favicon.ico”,
“points”: 1,
“_id”: 1,
“_parent_id” : 0,
“description”: “You registered! Let the achieving

begin”
}

In one particular implementation, achievement progression steps or achievement points may comprise any suitable values, such as, for example, one or more integers, though claimed subject matter is not so limited. Some non-limiting examples of achievement points along with example narratives in connection with an achievement scheme may include those presented in Table 2 below.

TABLE 2
Example achievement points.

| | |
|---|---|
| 1 point | Very easy (e.g., user registration, etc.) |
| 5 points | Relatively easy (e.g., 5 posts on a message board, etc.) |
| 15 points | Medium (e.g., used an on-line property for 2 hours, etc.) |
| 30 points | Relatively hard (e.g., top 10 views or clicks of the day, etc.) |
| 60 points | Very hard (e.g., earned an “expert” status, etc.) |

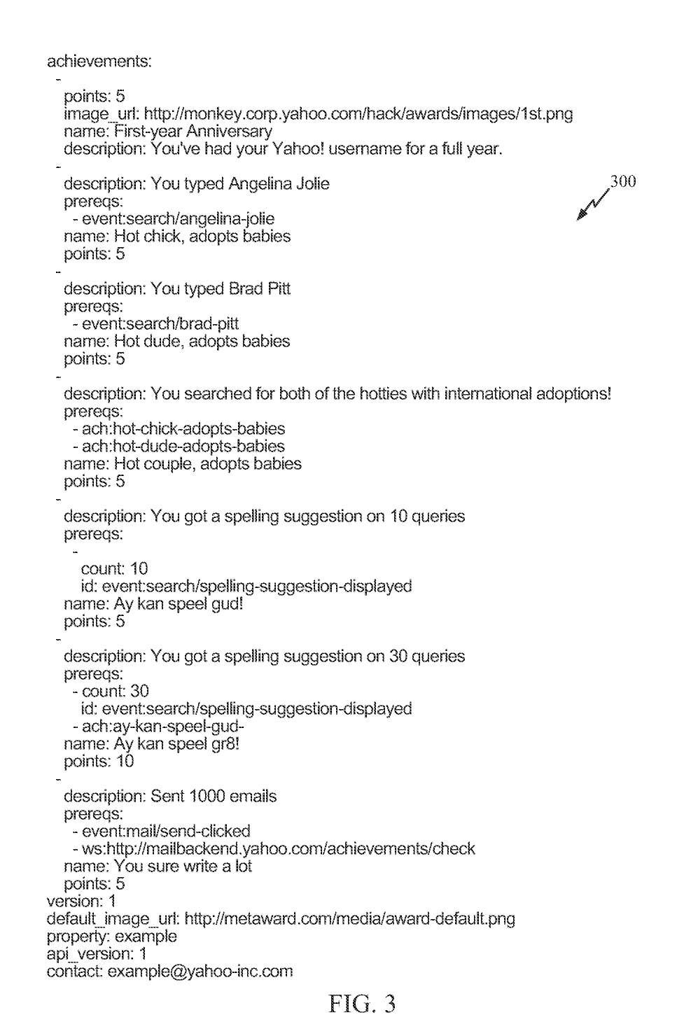

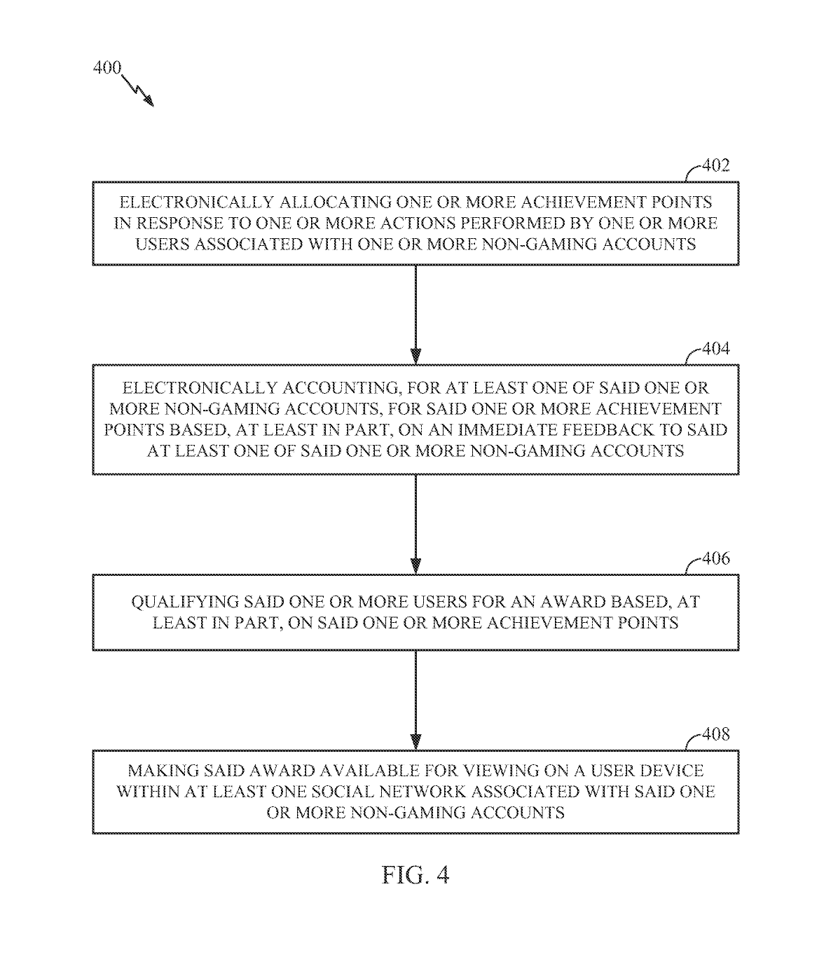

Following the above discussion, FIG. 3 illustrates an implementation of a format 300 that may, for example, be considered, partially, dominantly, or substantially, so as to facilitate or support one or more processes or operations associated with non-gaming on-line achievement awards with respect to one or more example on-line properties. It should be appreciated that format 300, which is self-explanatory, is provided herein by way of a non-limiting example and may comprise, for example, any suitable information structure or distribution (e.g., associative arrays, lists, strings, notations, etc.), syntax or semantics (e.g., YAML, JavaScript™, HTML, JavaScript™ Object Notation (JSON), etc.), presentation, or the like. Briefly, in this illustrated example, preqeqs may comprise an array descriptive of pre-existing events (e.g., “pre-requisite” or lower level achievements, etc.), for example, or if preqeqs values are not present (e.g., not desired, required, needed, etc.), process or operation may “default” to event:*property*/*id* values (e.g., property or ID-defined events, etc.), with an asterisk*representing specific property-related or user ID-related information. Optionally or alternatively, entries in a preqeqs array may comprise, for example, a dictionary with one or more supported keys, such as id put (e.g., in the same or similar form as prereqs, etc.) in the array version of prereqs, or count being the number of times the name event has to happen (e.g., for an achievement, etc.). In one particular simulation or experiment, points included an integer having sample values from [0, 150], and a validation or verification process (e.g., ws:*url* values, etc.) comprised a back-end (e.g., server-side, etc.) special purpose computing platform returning a 1 or single-value character responses (e.g., “0” if invalidated or “1” if validated, etc.). Again, techniques used in signal processing or related arts (e.g., encoding, decoding, etc.) in connection with software-related code or instructions (e.g., computer-readable, human-readable, etc.) are known and need not be described here in greater detail. In addition, those of skill in the art may recognize that one or more processes or operations illustrated in FIG. 3 or otherwise associated with non-gaming on-line achievement awards, for example, may be implemented in a variety of ways or may be rearranged, combined, omitted, etc. without departing from illustrated principles.

Attention is drawn next to FIG. 4, which is a flow diagram illustrating an implementation of an example process 400 that may be implemented in one or more special purpose computing platforms or apparatuses, partially, dominantly, or substantially, to facilitate or support one or more processes associated with non-gaming on-line achievement awards. It should be appreciated that information applied or produced, such as, for example, inputs, applications, outputs, operations, results, etc. associated with example process 400 may be represented by one or more digital signals. It should also be noted that even though one or more operations are illustrated or described with respect to a certain sequence, other sequences including, for example, parallel operations may also be employed.

Example process 400 may begin, for example, at operation 402 with electronically allocating one or more achievement points in response to one or more actions performed by one or more users associated with one or more non-gaming accounts. As was indicated, a non-gaming account may be established or created by a user or client with respect to an on-line system, which may be associated with a particular service provider, such as Yahoo!® (e.g., www.yahoo.com), for example. These one or more actions may require, for example, a certain level or amount of user skill, effort, training, knowledge, etc. rather than mere repetitious activity. For example, actions may comprise performing an on-line search using one or more Boolean operators, searching for a trending topic, writing a successful movie review, posting an interesting photo, or the like. At operation 404, one or more achievement points may, for example, be electronically accounted for or brought to the attention of a user or a group of users based, at least in part, on an immediate feedback to at least one of one or more non-gaming accounts, as previously mentioned. As was also indicated, immediate feedback may alert a user to the fact that the user attained or earned an award (e.g., of achievement points, etc.), which may encourage continued user participation or provide, for example, an incentive or motivation to pursue other on-line activities in connection with a particular service provider. With regard to operation 406, one or more users may, for example, be qualified for an award based, at least in part, on one or more achievement points. In one particular implementation, an award may comprise, for example, a badge (e.g., virtual, etc.) or like collectible feature, which a user may keep on a “virtual display” on a user profile page, for example, though claimed subject matter is not so limited. As a way of illustration, a badge may be associated with a particular on-line property or a group of on-line properties and may comprise, for example, an image, icon (e.g., badge or trophy-shaped, etc.), or like artistic rendering along with an inscription, legend, or other achievement-related information. At operation 408, an award may be made available for viewing on a user or client device, for example, within at least one social network associated with one or more non-gaming accounts. For example, a user may show off an award by keeping it on a “virtual display” or “Trophy Case,” for example, for a group of users associated with an on-line social network to see. Optionally or alternatively, a user may restrict showing or displaying an award or other collectible features to selected users, for example, by utilizing appropriate settings, filters, controls, or like features that may be provided by an on-line property, service provider, social network, or the like.

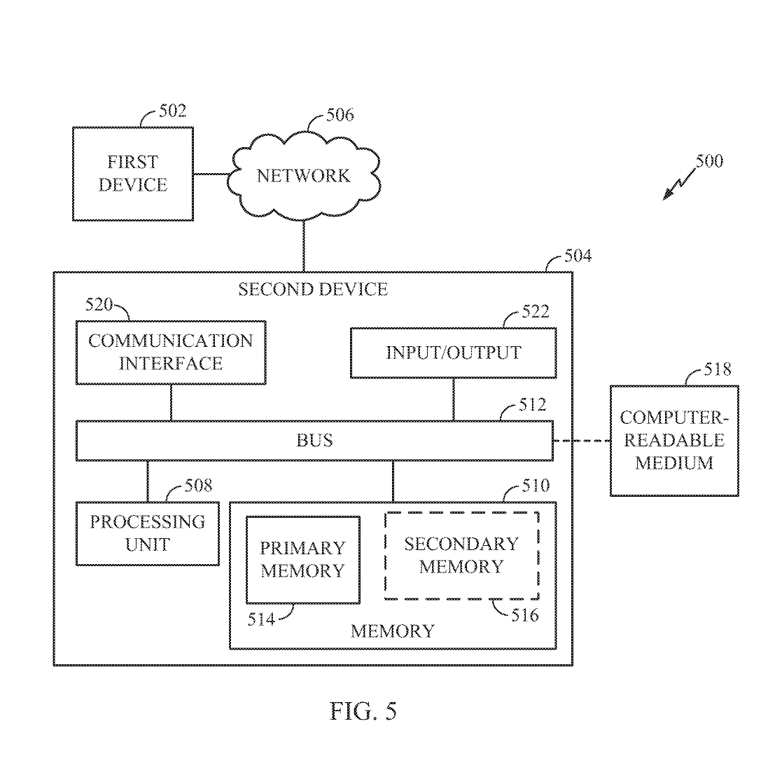

FIG. 5 is a schematic diagram illustrating an example computing environment 500 that may include one or more devices that may be configurable to implement a process for non-gaming on-line achievement awards, partially, dominantly, or substantially, in the context of an achievement scheme, on-line or off-line experiments or simulations, modeling, or the like.

Computing environment system 500 may include, for example, a first device 502 and a second device 504, which may be operatively coupled together via a network 506. In an embodiment, first device 502 and second device 504 may be representative of any electronic device, appliance, or machine that may have capability to exchange information over network 506. Network 506 may represent one or more communication links, processes, or resources having capability to support exchange or communication of information between first device 502 and second device 504. Second device 504 may include at least one processing unit 508 that may be operatively coupled to a memory 510 through a bus 512. Processing unit 508 may represent one or more circuits to perform at least a portion of one or more information computing procedures or processes.

Memory 510 may represent any information storage mechanism. For example, memory 510 may include a primary memory 514 and a secondary memory 516. Primary memory 514 may include, for example, a random access memory, read only memory, etc. In certain implementations, secondary memory 516 may be operatively receptive of, or otherwise have capability to be coupled to, a computer-readable medium 518.

Computer-readable medium 518 may include, for example, any medium that can store or provide access to information, code or instructions for one or more devices in system 500. It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, just to illustrate one possible implementation. As such, “non-transitory” may refer, for example, to any medium or device remaining tangible despite this change in state.

Second device 504 may include, for example, a communication adapter or interface 520 that may provide for or otherwise support communicative coupling of second device 504 to a network 506. Second device 504 may include, for example, an input/output device 522. Input/output device 522 may represent one or more devices or features that may be able to accept or otherwise input human or machine instructions, or one or more devices or features that may be able to deliver or otherwise output human or machine instructions.

According to an implementation, one or more portions of an apparatus, such as second device 504, for example, may store one or more binary digital electronic signals representative of information expressed as a particular state of a device, for example, second device 504. For example, an electrical binary digital signal representative of information may be “stored” in a portion of memory 510 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, for example, memory device 510, to a different state or thing.

Thus, as illustrated in various example implementations or techniques presented herein, in accordance with certain aspects, a method may be provided for use as part of a special purpose computing device or other like machine that accesses digital signals from memory and processes such digital signals to establish transformed digital signals which may be stored in memory as part of one or more information files or a database specifying or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
applying an achievement scheme to one or more non-gaming accounts, said achievement scheme comprising:
electronically allocating one or more achievement points in response to one or more actions performed by one or more users associated with said one or more non-gaming accounts; and
electronically accounting, for at least one of said one or more non-gaming accounts, for said one or more achievement points based, at least in part, on an immediate feedback to said at least one of said one or more non-gaming accounts.

2. The method of claim 1, wherein said applying said achievement scheme to said one or more non-gaming accounts further comprises applying said achievement scheme across one or more on-line properties.

3. The method of claim 2, wherein said applying said achievement scheme across said one or more on-line properties further comprises applying said achievement scheme across multiple unrelated web pages associated with at least one search engine information management system.

4. The method of claim 2, wherein said applying said achievement scheme across said one or more on-line properties further comprises applying said achievement scheme across a network of at least partially related web pages.

5. The method of claim 1, wherein said electronically allocating said one or more achievement points further comprises electronically validating whether said one or more actions qualify said one or more users for said one or more achievement points.

6. The method of claim 5, wherein said electronically validating whether said one or more actions qualify said one or more users for said one or more achievement points is performed using one or more server-side processes.

7. The method of claim 1, wherein said applying said achievement scheme to said one or more non-gaming accounts further comprises qualifying said one or more users for an award based, at least in part, on said one or more achievement points.

8. The method of claim 7, and further comprising making said award available for viewing on a user device within at least one social network associated with said one or more non-gaming accounts.

9. The method of claim 7, and further comprising making names of said one or more users qualified for said award available for viewing on a user device within at least one social network associated with said one or more non-gaming accounts.

10. The method of claim 1, wherein said electronically allocating said one or more achievement points further comprises electronically allocating one or more redeemable achievement points.

11. The method of claim 1, wherein said applying said achievement scheme to said one or more non-gaming accounts further comprises qualifying said one or more users for at least one of the following: an overt award; a covert award; or any combination thereof.

12. The method of claim 1, wherein said one or more non-gaming accounts comprises an on-line search.

13. An article comprising:
a storage medium having instructions stored thereon executable by a special purpose computing platform to:
apply an achievement scheme to one or more non-gaming accounts to:
electronically allocate one or more achievement points in response to one or more actions performed by one or more users associated with said one or more non-gaming accounts; and
electronically account, for at least one of said one or more non-gaming accounts, for said one or more achievement points based, at least in part, on an immediate feedback to said at least one of said one or more non-gaming accounts.

14. The article of claim 13, wherein said storage medium having instructions to apply said achievement scheme to said one or more non-gaming accounts further includes instructions to apply said achievement scheme across one or more on-line properties.

15. The article of claim 13, wherein said storage medium having instructions to electronically allocate said one or more achievement points further comprises instructions to electronically validate whether said one or more actions qualify said one or more users for said one or more achievement points.

16. The article of claim 13, wherein said storage medium having instructions to apply said achievement scheme to said one or more non-gaming accounts further comprises instructions to qualify said one or more users for an award based, at least in part, on said one or more achievement points.

17. An apparatus comprising:
a communication interface adapted to communicate one or more digital signals via a communication network; and
a computing platform enabled to:
apply an achievement scheme to one or more non-gaming accounts to:
electronically allocate one or more achievement points in response to one or more actions performed by one or more users associated with said one or more non-gaming accounts; and
electronically account, for at least one of said one or more non-gaming accounts, for said one or more achievement points based, at least in part, on an immediate feedback to said at least one of said one or more non-gaming accounts.

18. The apparatus of claim 17, wherein said computing platform enabled to apply said achievement scheme to said one or more non-gaming accounts further enabled to apply said achievement scheme across one or more on-line properties.

19. The apparatus of claim 18, wherein said computing platform enabled to apply said achievement scheme across said one or more on-line properties further enabled to apply said achievement scheme across a network of at least partially related web pages.

20. The apparatus of claim 17, wherein said computing platform enabled to apply said achievement scheme to said one or more non-gaming accounts further enabled to qualify said one or more users for at least one of the following: an overt award; a covert award; or any combination thereof.
